(19) United States
(12) Patent Application Publication
(10) Pub. No.: US 2024/0266741 A1
(43) Pub. Date: Aug. 8, 2024

(54) ANTENNA AND VEHICLE

(71) Applicants: CHENGDU TIANMA MICROELECTRONICS CO., LTD., Chengdu (CN); SHANGHAI TIANMA MICROELECTRONICS CO., LTD., Shanghai (CN)

(72) Inventors: Yifan XING, Shanghai (CN); Yifan BAO, Shanghai (CN); Baiquan LIN, Shanghai (CN); Qiongqin MAO, Shanghai (CN); Xiaonan HAN, Shanghai (CN); Linzhi WANG, Shanghai (CN); Su GAO, Shanghai (CN); Qinyi DUAN, Chengdu (CN); Zhenyu JIA, Xiamen (CN)

(73) Assignees: CHENGDU TIANMA MICROELECTRONICS CO., LTD., Chengdu (CN); SHANGHAI TIANMA MICROELECTRONICS CO., LTD., Shanghai (CN)

(21) Appl. No.: 18/617,659

(22) Filed: Mar. 27, 2024

(30) Foreign Application Priority Data
Aug. 17, 2023 (CN) 202311048913.6

(51) Int. Cl. H01Q 9/04; H01Q 1/27

(52) U.S. Cl. CPC H01Q 9/0407; H01Q 1/27

(57) ABSTRACT

In a first direction, a first radiator in an antenna is located in a first area, and a second radiator in the antenna is located in a second area. In a second direction, multiple radiators have a same maximum length. Each radiator has a first radiation portion, a second radiation portion, and a third radiation portion connected in sequence. The first radiation portion is located on one side of the second radiation portion towards the second area. The third radiation portion is located on one side of the second radiation portion. In the first direction, a length of the first radiation portion and a length of the third radiation portion are the same. The first radiator has a first radiation center, and the second radiator has a second radiation center. In the second radiator, the second radiation center is located on an axis of the second radiation portion.

### CROSS REFERENCE TO RELATED APPLICATIONS

This application claims the priorities to Chinese patent application Ser. No. 202311048913.6, titled “ANTENNA AND VEHICLE”, filed with the China National Intellectual Property Administration on Aug. 17, 2023, the entire disclosure of which is hereby incorporated by reference.

### FIELD

The present application relates to the field of electromagnetic waves, and in particular to an antenna and a vehicle.

### BACKGROUND

At present, the application fields of antennas are increasingly wide. With the diversification of application products, a terminal having a curved antenna is required. However, there are many problems when a conventional antenna is directly used for a curved product. For example, the signal strength is uneven, and a signal direction is greatly different from a preset direction.

### SUMMARY

An antenna and a vehicle are provided according to the present application to solve problems, such as uneven signal strength and a large signal-direction deviation, of a conventional curved antenna.

According to one embodiment of the present application, an antenna is provided, including a flexible substrate and multiple radiators. The flexible substrate has a first surface, and the multiple radiators are distributed and spaced apart along a first direction at a side of the first surface. The flexible substrate includes a first area and a second area. The first area is located on at least one side of the second area in the first direction. At least one first radiator among the multiple radiators is located in the first area, and at least one second radiator among the multiple radiators is located in the second area. The multiple radiators have a same maximum length in a second direction perpendicular to the first direction and parallel to the first surface. Each of the multiple radiators has a first radiation portion, a second radiation portion, and a third radiation portion connected in sequence. The first radiation portion is located on a side of the second radiation portion close the second area, and the third radiation portion is located on a side, away from the second area, of the second radiation portion. The first radiation portion and the third radiation portion have a same length in the first direction. Each of the at least one first radiator has a first radiation center, and each of the at least one second radiator has a second radiation center. In the second radiator, the second radiation center is located on an axis of the second radiation portion, and in the first radiator, the first radiation center is located on one side of an axis of the second radiation portion.

According to another embodiment of the present application, an antenna is provided, including a flexible substrate and multiple radiators. The flexible substrate has a first surface, and the multiple radiators are distributed and spaced apart along a first direction at a side of the first surface. The flexible substrate includes a first area and a second area. The first area is located on at least one side of the second area in the first direction. At least one first radiator among the multiple radiators is located in the first area, and at least one second radiator among the multiple radiators is located in the second area. Each of the multiple radiators is of a grid structure formed by the intersection of multiple first metal wires and multiple second metal wires. An extension direction of the multiple first metal wires is perpendicular to an extension direction of the multiple second metal wires. Two adjacent first metal wires and two adjacent second metal wires form a radiation unit. In the radiation unit in each of the at least one second radiator, the extension direction of the first metal wires is a second direction perpendicular to the first direction and parallel to the first surface, and in the radiation unit in each of the at least one first radiator, there is an included angle between the extension direction of the first metal wires and the second direction.

According to another embodiment of the present application, a vehicle is also provided, which includes a vehicle body and the antenna described above. The vehicle body has a first curved surface. The antenna is located on the first curved surface.

In the antenna according to the embodiments of the present application, in view of the uneven radiation intensity of the radiator caused by the bending of the antenna substrate, the shape of the radiator on the antenna substrate is designed. Each radiator is divided into the first radiation portion, the second radiation portion, and the third radiation portion connected in sequence. In the case that the antenna substrate is not bent, in the first direction, the first radiation portion towards the inner side and the third radiation portion towards the outer side in the radiator have the same length. The second radiation center of the second radiator is located on the axis of the second radiation portion, and the first radiation center of the first radiator is located on one side of the axis of the second radiation portion, and the antenna substrate can compensate for the uneven radiation caused by bending deformation in the case that the antenna substrate is bent. For the antenna substrate that protrudes after being bent, since the end of the radiator towards the outer side inclines downwards along with the bending of the antenna substrate, the radiation intensity decreases from the inner side to the outer side. In the embodiments of the present application, the shape of the radiator on the antenna substrate is designed. The radiation intensity of an end portion of a side, towards the outer side, of the radiator can be greater than the radiation intensity of an end portion of a side towards the inner side by changing the position of the radiation center of the radiator, and the radiator located on the outer side has radiation compensation towards the inner side, achieving compensation for the uneven radiation of the radiator. In addition, for the antenna substrate that is recessed after being bent, since the end of the radiator towards the outer side inclines upward along with the bending of the antenna substrate, the radiation intensity increases from the inner side to the outer side. In the embodiments of the present application, the shape of the radiator on the antenna substrate is designed. The radiation intensity of an end portion of a side, towards the outer side, of the radiator can be smaller than the radiation intensity of an end portion of a side towards the inner side by changing the position of the radiation center of the radiator, and the outer radiator located on the outer side has radiation compensation away from the inner side, achieving compensation for the uneven radiation of the radiator.

### BRIEF DESCRIPTION OF THE DRAWINGS

The drawings, which constitute a part of the present application, are used to provide a further understanding of the present application. The illustrative embodiments of the present application and the description thereof are used to explain the present application and do not constitute an improper limitation of the present application.

FIG. 1 is a schematic cross-sectional structural diagram of an antenna according to an embodiment of the present application;

FIG. 2 is a schematic cross-sectional structural diagram of the antenna shown in FIG. 1 in which at least part of an area has a first bending state;

FIG. 3 is a schematic cross-sectional structural diagram of the antenna shown in FIG. 1 in which at least part of an area has a second bending state;

FIG. 4 is a schematic cross-sectional structural diagram of the antenna shown in FIG. 1 which has the first bending state and the second bending state;

FIG. 5 is a schematic top view of an antenna according to an embodiment of the present application, where a flexible substrate includes a first bendable portion;

FIG. 6 is a schematic top view of an area A in the antenna shown in FIG. 5;

FIG. 7 is a schematic top view of another antenna according to an embodiment of the present application, where a flexible substrate includes a second bendable portion;

FIG. 8 is a schematic top view of an area A′ in the antenna shown in FIG. 7;

FIG. 9 is a schematic top view of another antenna according to an embodiment of the present application, where a flexible substrate includes a first bendable portion;

FIG. 10 is a schematic top view of another antenna according to an embodiment of the present application, where a flexible substrate includes a second bendable portion;

FIG. 11 is a schematic top view of an area B in the antenna shown in FIG. 9 or FIG. 10;

FIG. 12 is a schematic top view of an area B′ area in the antenna shown in FIG. 9 or FIG. 10;

FIG. 13 is a schematic top view of another antenna according to an embodiment of the present application, where a flexible substrate includes a first bendable portion;

FIG. 14 is a schematic top view of another antenna according to an embodiment of the present application, where a flexible substrate includes a second bendable portion;

FIG. 15 is a schematic top view of an area C in the antenna shown in FIG. 13 or FIG. 14;

FIG. 16 is a schematic top view of an area C′ in the antenna shown in FIG. 13;

FIG. 17 is a schematic top view of an area C″ in the antenna shown in FIG. 14;

FIG. 18 is a schematic top view of an antenna according to an embodiment of the present application, where a ground electrode and a radiator are located on a same surface;

FIG. 19 is a schematic top view of another antenna according to an embodiment of the present application, where a ground electrode and a radiator are located on a same surface;

FIG. 20 is a schematic cross-sectional structural diagram of another antenna according to an embodiment of the present application, where a ground electrode and a radiator are located on different surfaces;

FIG. 21 is a schematic cross-sectional structural diagram of an antenna including flexible glass according to an embodiment of the present application;

FIG. 22 is a schematic cross-sectional structural diagram of an antenna including an organic material layer and a first insulation layer according to an embodiment of the present application;

FIG. 23 is a schematic cross-sectional structural diagram of an antenna including an organic material layer and a second insulation layer according to an embodiment of the present application;

FIG. 24 is a schematic top view of another antenna according to an embodiment of the present application, where a flexible substrate includes a first bendable portion;

FIG. 25 is a schematic top view of another antenna according to an embodiment of the present application, where a flexible substrate includes a second bendable portion;

FIG. 26 is a schematic top view of a second radiator in the antenna shown in FIG. 24 or FIG. 25;

FIG. 27 is a schematic top view of a first radiator in the antenna shown in FIG. 24; and

FIG. 28 is a schematic top view of a first radiator in the antenna shown in FIG. 25.

The reference signs in the above figures are listed as follows:

10. flexible substrate; 101. first area; 102. second area; 110. flexible glass; 120. organic material layer; 130. first insulation layer; 140. second insulation layer; 20. radiator; 201. first radiator; 202. second radiator; 210. first radiation portion; 220. second radiation portion; 230. third radiation portion; 240. first metal wire; 250. second metal wire; 310. first feeder; 320. second feeder; 330. third feeder; 340. fourth feeder; and 40. ground electrode.

### DETAILED DESCRIPTION OF EMBODIMENTS

It should be noted that, in the case of no conflict, the embodiments in the present application and features in the embodiments may be combined with each other. The present application is described in detail below with reference to the drawings and in conjunction with the embodiments.

The embodiments of the present application are clearly and completely described below in conjunction with the drawings. Apparently, the described embodiments are only part of the embodiments of the present application, not all of the embodiments of the present application.

It should be noted that terms such as “first” and “second” in the description, claims and the drawings of the present application, are used to distinguish similar objects, and are not necessarily used to describe a specific order or sequence. It should be understood that the terms used in this way are interchangeable under appropriate circumstances for the embodiments of the present application described herein. In addition, terms “comprise” and “have”, and any variations thereof, are intended to cover a non-exclusive inclusion. For example, a process, method, system, product, or device that includes a series of steps or units, is not limited to the steps or units explicitly listed, but may include other steps or units not explicitly listed or inherent to the process, method, product, or device.

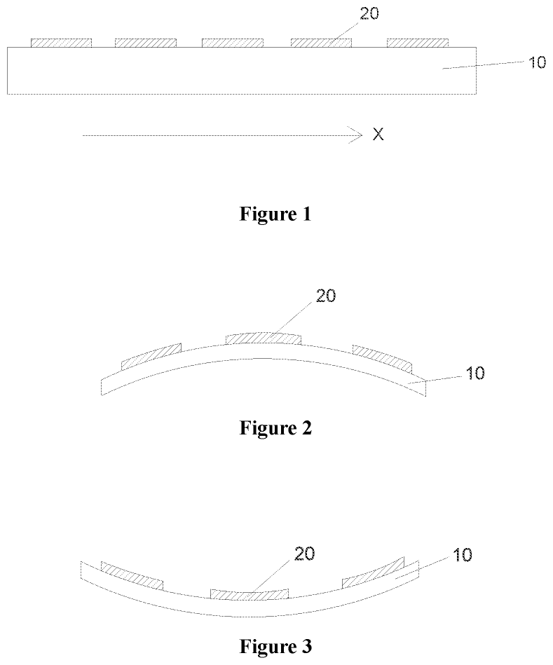

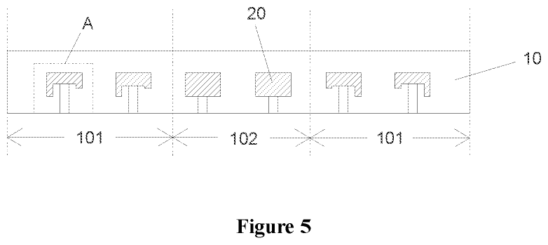

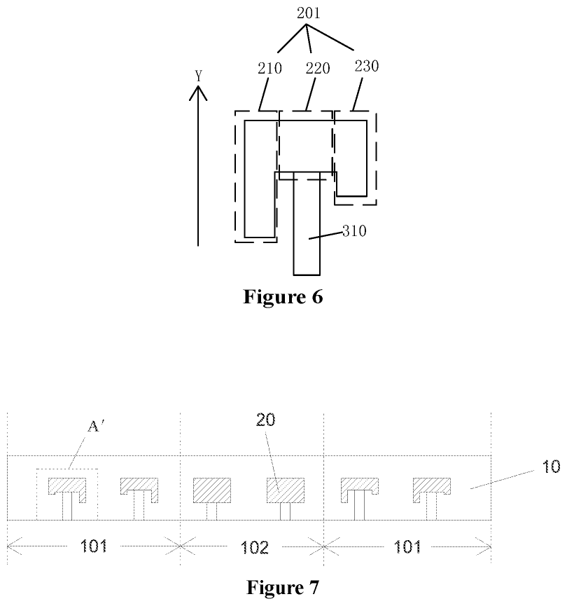

According to an embodiment of the present application, an antenna is provided, as shown in FIGS. 1 to 17. The antenna includes a flexible substrate 10 and multiple radiators 20, as shown in FIGS. 1 to 4. The flexible substrate 10 has a first surface. The multiple radiators 20 are distributed and spaced apart along a first direction X at a side of the first surface. The flexible substrate includes a first area 101 and a second area 102. In the first direction X, the first area 101 is located on at least one side of the second area 102. At least one first radiator of the multiple first radiators 20 is located in the first area 101, and at least one second radiator of the multiple radiators 20 is located in the second area 102, as shown in FIGS. 5, 7, 9, 10, 13 and 14. In a second direction Y perpendicular to the first direction X and parallel to the first surface, the multiple radiators 20 have the same maximum length. Each radiator has a first radiation portion 210, a second radiation portion 220, and a third radiation portion 230 that are connected in sequence. The first radiation portion 210 is located on a side of the second radiation portion 220 towards the second area 102. The third radiation portion 230 is located on a side, away from the second area 102, of the second radiation portion 220. In the first direction X, the first radiation portion 210 and the third radiation portion 230 have the same length. The first radiator 201 has a first radiation center. The second radiator 202 has a second radiation center. In the second radiator 202, the second radiation center is located on an axis of the second radiation portion. In the first radiator, the first radiation center is located on one side of an axis of the second radiation portion, as shown in FIGS. 6, 8, 11, 12 and 15 to 17.

It should be noted that the projection shape of the radiator on the first surface of the flexible substrate is not specifically limited in the embodiment of the present application. Therefore, the radiator may not necessarily have a unique length in the second direction. Taking a first radiator 201 shown in FIG. 6 as an example, in the second direction Y, the first radiator 201 has a first radiation portions 210, a second radiation portions 220, and a third radiation portions 230 connected in sequence. A length of the first radiation portion 210 along the second direction Y is the maximum length of the first radiator 201.

It should be noted that, in this embodiment, the first radiation portion 210, the second radiation portion 220, and the third radiation portion 230 are of an integrated structure, that is, they are made of the same material and formed through the same process.

Through the above embodiments, in view of the uneven radiation intensity of the radiator caused by the bending of an antenna substrate, the shape of the radiator on the antenna substrate is designed. After the radiator is divided into the first radiation portion, the second radiation portion, and the third radiation portion connected in sequence, in the case that the antenna substrate is not bent, the first radiation portion towards the inner side and the third radiation portion towards the outer side in the first radiator are allowed to have the same length in the first direction, and to facilitate the adjustment of the first radiation center of the first radiator, to optimize the shapes of the first radiation portion and the third radiation portion, or optimizing the axis positions of the first radiation portion and the third radiation portion. The position of the first radiation center of the first radiator can be adjusted, and to allow the first radiation center to be located on one side of the axis of the second radiation portion, and the position of the second radiation center of the second radiator remains unchanged and is still located on the axis of the second radiation portion, and when the antenna applied to a scene that requires the antenna to be bent, in the case that the antenna substrate is bent, the radiation center of the first radiator located on the outer side generates an offset towards one side of the axis. Since the first radiation center of the first radiator is located on one side of the axis of the second radiation portion, the offset caused by the bending can be compensated, achieving compensation for the uneven radiation caused by bending deformation.

For the antenna substrate that protrudes after being bent, since an end of the radiator towards the outer side inclines downwards along with the bending of the antenna substrate, the radiation intensity decreases from the inner side to the outer side. In the embodiments of the present application, the shape of the radiator on the antenna substrate is designed. The radiation intensity of an end portion of a side, towards the outer side, of the radiator can be greater than the radiation intensity of an end portion of a side towards the inner side by changing the position of the radiation center of the radiator, and the radiator located on the outer side has radiation compensation towards the inner side, achieving compensation for the uneven radiation of the radiator.

In addition, for the antenna substrate that is recessed after being bent, since the end of the radiator towards the outer side inclines upward along with the bending of the antenna substrate, the radiation intensity increases from the inner side to the outer side. In the embodiments of the present application, the shape of the radiator on the antenna substrate is designed. The radiation intensity of the end portion of the side, towards the outer side, of the radiator can be smaller than the radiation intensity of the end portion of the side towards the inner side by changing the position of the radiation center of the radiator, and the radiator located on the outer side has radiation compensation away from the inner side, achieving compensation for the uneven radiation of the radiator.

The embodiments of the present application are clearly and completely described below in conjunction with the drawings in the embodiments of the present application.

FIG. 1 shows a schematic cross-sectional structural diagram of an antenna in an embodiment. As shown in FIG. 1, the antenna includes a flexible substrate 10 and multiple radiators 20. The multiple radiators 20 are distributed and spaced apart along the first direction X on a first surface of the flexible substrate 10.

In some embodiments, the flexible substrate includes at least one bendable portion. Each of the at least one bendable portion has a sub-area located in the first surface. Each sub-area has a second area and first areas located on opposite sides of the second area. The bendable portion is bendable in different application scenarios, and the antenna is suitable for the application scenarios. When a flexible antenna in the conventional technology is applied in a specific situation and an antenna substrate is bent, radiators located at different positions on the antenna substrate is also bent with the antenna substrate, and a radiator located on the outer side inclines towards the outer side along with the bending of the antenna substrate, and the radiation intensity of the radiator is uneven. In this embodiment, by designing the shape of the radiator on the antenna substrate, each radiator is divided into the first radiation portion, the second radiation portion, and the third radiation portion connected in sequence. Without bending the antenna substrate, the first radiation portion towards the inner side and the third radiation portion towards the outer side in the radiator have the same length in the first direction, the second radiation center of the second radiator is located on the axis of the second radiation portion, and the first radiation center of the first radiator is located on one side of the axis of the second radiation portion, and in the case that the antenna substrate is bent, the radiator can compensate for uneven radiation caused by bending deformation.

In an embodiment, the flexible substrate includes a first bendable portion. The first bendable portion has a first bending state in the case of bending. The first bending state satisfies the following conditions: a sub-area corresponding to the first bendable portion is a convex surface, and in the sub-area corresponding to the first bendable portion, the first areas on opposite sides of the second area are arranged opposite to each other.

In one embodiment, FIG. 2 shows a schematic cross-sectional structural diagram of an antenna according to an embodiment that has the first bending state. As shown in FIG. 2, a middle portion of a flexible substrate 10 protrudes upwards, and both sides of the flexible substrate 10 are lower than the middle portion. Multiple radiators 20 are distributed and spaced apart along the first direction X on a first surface of the flexible substrate 10.

In the above embodiment, for an antenna substrate in the conventional technology that protrudes after being bent, an end of a radiator towards the outer side inclines downwards along with the bending of the antenna substrate, so the radiation intensity decreases from the inner side to the outer side. At this time, the radiation intensity of a side of the radiator towards the outer side is decreased, resulting in uneven radiation intensity of the radiator. For the antenna substrate according to the embodiment that protrudes after being bent, by designing the shape of the radiator located on the outer side of the antenna substrate, the radiation intensity of an end portion of a side, towards the outer side, of the radiator is greater than the radiation intensity of an end portion of a side towards the inner side, and the radiator located on the outer side has radiation compensation towards the inner side.

In an embodiment, the flexible substrate includes a second bendable portion. The second bendable portion has a second bending state in the case of bending. The second bending state satisfies the following conditions: a sub-area corresponding to the second bendable portion is a concave surface, and in the sub-area corresponding to the second bendable portion, the first areas on opposite sides of the second area are arranged opposite to each other.

In one embodiment, FIG. 3 shows a schematic cross-sectional structural diagram of an antenna according to an embodiment that has the second bending state. As shown in FIG. 3, a middle portion of a flexible substrate 10 is recessed downwards, so both sides of the flexible substrate 10 are higher than the middle portion. Multiple radiators 20 are distributed and spaced apart along the first direction X on a first surface of the flexible substrate 10.

In the above embodiment, for an antenna substrate in the conventional technology that is recessed after being bent, an end of a radiator towards the outer side inclines upwards along with the bending of the antenna substrate, so the radiation intensity increases from the inner side to the outer side. At this time, the radiation intensity of a side, towards the outer side, of the radiator is increased, which also leads to uneven radiation intensity of the radiator. For the antenna substrate according to the embodiment that is recessed after being bent, by designing the shape of the radiator on the antenna substrate, the radiation intensity of an end portion of a side, towards the outer side, of the radiator is smaller than the radiation intensity of an end portion of a side towards the inner side, and the radiator located on the outer side has radiation compensation away from the inner side.

In an embodiment, the flexible substrate includes a first bendable portion and a second bendable portion. The first bendable portion has a first bending state in the case of bending, and the first bending state satisfies the following conditions: a sub-area corresponding to the first bendable portion is a convex surface, and in the sub-area corresponding to the first bendable portion, the first areas on opposite sides of the second area are arranged opposite to each other. The second bendable portion has a second bending state in the case of bending, and the second bending state satisfies the following conditions: a sub-area corresponding to the second bendable portion is a concave surface, and in the sub-area corresponding to the second bendable portion, the first areas on opposite sides of the second area are arranged opposite to each other.

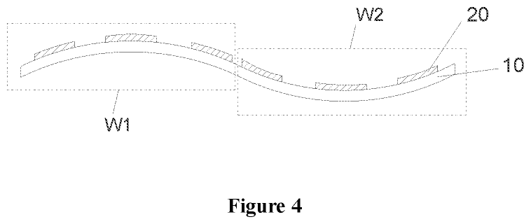

In one embodiment, FIG. 4 shows a schematic cross-sectional structural diagram of an antenna according to an embodiment that has the first bending state and the second bending state. As shown in FIG. 4, a flexible substrate includes a first bendable portion W1 and a second bendable portion W2. A middle portion of the first bendable portion W1 protrudes upwards, so both sides of the flexible substrate 10 are lower than the middle portion. Multiple radiators 20 are distributed and spaced apart along the first direction X on a first surface of the flexible substrate 10. The middle portion of the second bendable portion W2 is recessed downwards, so both sides of the flexible substrate 10 are higher than the middle portion. Multiple radiators 20 are distributed and spaced apart along the first direction X on the first surface of the flexible substrate 10.

In the above embodiment, for an antenna substrate in the conventional technology where a first area protrudes after being bent and a second area protrudes after being bent, in the first area, an end of a radiator towards the outer side inclines downwards along with the bending of the antenna substrate, so the radiation intensity decreases from the inner side to the outer side, and the radiation intensity of a side, towards the outer side, of the radiator is decreased. In the second area, an end of a radiator towards the outer side inclines upwards along with the bending of the antenna substrate, so the radiation intensity increases from the inner side to the outer side, and the radiation intensity of a side, towards the outer side, of the radiator is increased. Thus, the radiation intensity of the radiator is uneven. For the antenna substrate according to the embodiment where the first bendable portion protrudes after being bent and the second bendable portion protrudes after being bent, by designing the shape of the radiator on the antenna substrate, on the first bendable portion, the radiation intensity of an end portion of a side, towards the outer side, of the radiator is greater than the radiation intensity of an end portion of a side towards the inner side, and the radiator located on the outside has radiation compensation towards the inner side. On the second bendable portion, the radiation intensity of an end portion of a side, towards the outer side, of the radiator is smaller than the radiation intensity of an end portion of a side towards the inner side, and the radiator located on the outer side has radiation compensation away from the inner side, to realize compensation for uneven radiation of the radiator.

In this embodiment, the shape of the radiator on the antenna substrate is designed to compensate for the uneven radiation of the radiator. In some embodiments, as shown in FIGS. 5 to 8, each radiator 20 has a first radiation portion 210, a second radiation portion 220, and a third radiation portion 230 connected in sequence. In the second direction Y, a maximum length of the first radiation portion 210 is a first length, and a maximum length of the third radiation portion 230 is a second length.

As shown in FIGS. 5 and 6, in the case that a flexible substrate 10 includes a first bendable portion, in a first radiator 201 located on the first bendable portion, the first length is smaller than the second length.

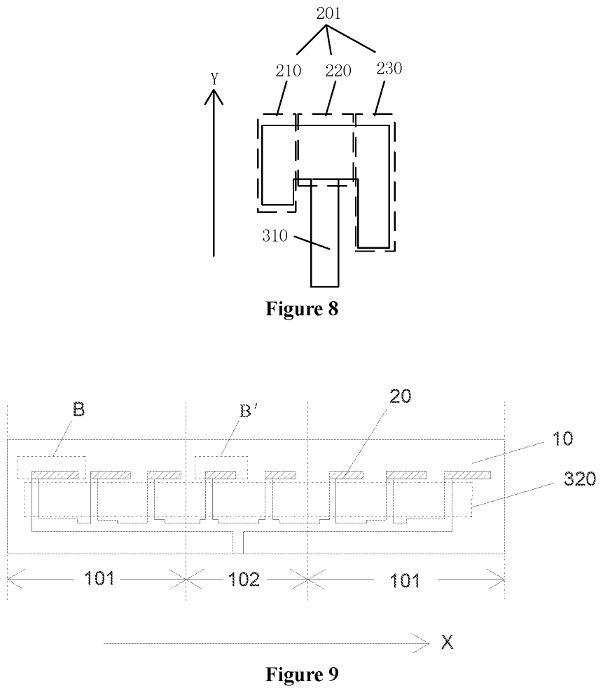

As shown in FIGS. 7 and 8, in the case that a flexible substrate 10 includes a second bendable portion, in a first radiator 201 located on the second bendable portion, the first length is greater than the second length.

In an embodiment, FIG. 5 shows a schematic top view of an antenna with a flexible substrate including a first bendable portion, and FIG. 6 shows a schematic top view of an area A in the antenna shown in FIG. 5. As shown in FIGS. 5 and 6, each radiator 20 has a first radiation portion 210, a second radiation portion 220, and a third radiation portion 230 connected in sequence. In the second direction Y, a maximum length of the first radiation portion 210 is a first length, and a maximum length of the third radiation portion 230 is the second length. In a first radiator 201 located on the first bendable portion, the first length is greater than the second length.

In one embodiment, the total current density distribution of multiple radiators is uniform. When the first bendable portion in the antenna substrate protrudes due to bending, on the first bendable portion, for a radiator located on the outer side can be designed to be a structure with a longer area towards the outer side and a shorter area towards the inner side, and the radiation center of the radiator located on the outer side is shifted leftwards, to compensate for the uneven radiation of the radiator.

In an embodiment, FIG. 7 shows a schematic top view of an antenna with a flexible substrate including a second bendable portion. FIG. 8 shows a schematic top view of an area A′ in the antenna shown in FIG. 7. As shown in FIGS. 7 and 8, each radiator 20 has a first radiation portion 210, a second radiation portion 220, and a third radiation portion 230 connected in sequence. In the second direction Y, a maximum length of the first radiation portion 210 is a first length, and a maximum length of the third radiation portion 230 is a second length. In a first radiator 201 located on the second bendable portion, the first length is smaller than the second length.

In one embodiment, the total current density distribution of multiple radiators is uniform. When the second bendable portion in the antenna substrate is recessed due to bending, on the second bendable portion, a radiator located on the outer side can be can be designed to be a structure with a shorter area towards the outer side and a longer area towards the inner side, and the radiation center of the radiator located on the outer side is shifted rightwards, to compensate for the uneven radiation of the radiator.

In order to further compensate for the uneven radiation of the radiator, in some embodiments, as shown in FIGS. 5 and 7, there are multiple radiators 20 on each first area 101, each of the multiple radiators 20 is the first radiator 201 shown in FIGS. 6 and 8.

As shown in FIGS. 5 and 6, in the case that the bendable portion is the first bendable portion, on the same first area 101 of the flexible substrate 10, the first lengths of the first radiation portions 210 in the radiators 20 decrease progressively along a direction away from the second area 102.

As shown in FIGS. 7 and 8, in the case that the bendable portion is the second bendable portion, on the same first area 101 of the flexible substrate 10, the second lengths of the third radiation portions 230 in the radiators 20 decrease in a direction away from the second area 102.

In one embodiment, when the flexible antenna is applied to a specific scenario and the antenna substrate is bent, the radiators located at different positions on the antenna substrate also incline with the bending of the antenna substrate. The radiator located on the outside inclines outwards with the bending of the antenna substrate, and different radiators have different inclination angles. In a direction from the middle to the outer side of the antenna substrate, the inclination angles of different radiators gradually increase. That is, a radiator closest to the middle has a minimum inclination angle, and a radiator located on the outermost side has a maximum radiation angle. Based on this, in the above embodiments of the present application, in the case that at least part of the area in the antenna protrudes upwards, compensation for uneven radiation of each radiator can be achieved by decreasing the lengths of the first radiation portions in the radiators progressively along a direction away from the middle. In the case that at least part of the area in the antenna is recessed downwards, compensation for uneven radiation of each radiator can also be achieved by decreasing the second lengths of the third radiation portions in the radiators progressively along a direction away from the second area.

In the above embodiments, as shown in FIGS. 5 to 8, in the second direction Y, a maximum length of the second radiation portion 220 is a third length. The third length may be smaller than a minimum length of the first length of the first radiation portion 210 and the second length of the third radiation portion 230. The first radiation portion 210, the second radiation portion 220, and the third radiation portion 230 satisfy the above length relationship. The function of the second radiation portion 220 is to realize the connection between the first radiation portion 210 and the third radiation portion 230, and lead out the first radiator 201 through a feeder. Therefore, the maximum length of the second radiation portion 220 is smaller than the maximum length of the first radiation portion 210 and the third radiation portion 230, and the cost can be reduced by reducing the overall size of the first radiator 201.

In the above embodiments, as shown in FIGS. 5 to 8, in the same first area 101 of the flexible substrate 10, the third lengths of the second radiation portions 220 in the radiators 20 decrease progressively along the direction away from the second area 102. When the flexible antenna is applied to a specific scenario and the antenna substrate is bent, the radiators located at different positions on the antenna substrate also incline with the bending of the antenna substrate. The radiator located on the outer side inclines outwards with the bending of the antenna substrate, and different radiators have different inclination angles. In a direction from the middle to the outer side of the antenna substrate, the inclination angles of the different radiators gradually increase. Based on this, in the above embodiments, the third lengths of the second radiation portions in the radiators gradually decreases in the direction away from the second area, and in a state in which the antenna substrate is not bent, the offsets of the radiation centers of the radiators sequentially distributed from the inner side to the outer side on the antenna substrate gradually changed. Thus, when the antenna substrate is bent, the gradient offsets can be used to compensate for intensity changes caused by the bending of the antenna substrate, to compensate for uneven radiation from the radiators in the bending state of the antenna substrates.

In the above embodiments, as shown in FIGS. 5 to 8, the first radiation portion 210 is in a first rectangle, the second radiation portion 220 is in a second rectangle, and the third radiation portion 230 is in a third rectangle. The first length of the first radiation portion 210 is the length of the first rectangle, and the second length of the second radiation portion 220 is the length of the third rectangle. The radiator is composed of multiple rectangular structures, which can facilitate the adjustment of the lengths of the first radiation portion 210 and the second radiation portion 220, and by reasonably setting the lengths of the first radiation portion 210 and the second radiation portion 220, the offset degree of the radiation center of the radiator can be used to compensate for changes of the radiation intensity caused by the bending of the antenna substrate, to facilitate the compensation for the uneven radiation of the radiators.

In the above embodiments, as shown in FIGS. 5 to 8, in the same first area 101 of the flexible substrate 10, ends, located on the same side, of the first radiation portion 210, the second radiation portion 220, and the third radiation portion 230 are flush. The first radiation portion 210, the second radiation portion 220, and the third radiation portion 230, which are connected in sequence in the radiator, have the flush ends, which can facilitate the adjustment of the lengths of the first radiation portion 210, the second radiation portion 220, and the third radiation portion 230, and the positional relationship of the ends of the first radiation portion 210, the second radiation portion 220, and the third radiation portion 230 located on the same side can be adjusted to reasonably set the lengths of the first radiation portion 210 and the second radiation portion 220, the offset degree of the radiation center of the radiator can be used to compensate for the change of the radiation intensity caused by the bending of the antenna substrate, to facilitate compensation for uneven radiation of each radiator.

In an embodiment, as shown in FIGS. 5 to 8, the antenna according to the embodiment may further include a first feeder 310. The first feeder 310 is connected to a second radiation portion 220 in each radiator 20, and the first feeder 310 has an extension direction along the second direction Y.

The first feeder 310 may be integrated with the first radiation portion 210, the second radiation portion 220, and the third radiation portion 230.

In addition to the shape design of the radiator according to the above embodiments, in order to compensate for the uneven radiation of the radiator, in other embodiments, as shown in FIGS. 9 to 12, each radiator 20 is divided into a first radiation portion 210, a second radiation portion 220, and a third radiation portion 230 connected in sequence along the first direction X. The lengths of the second radiation portion 220 in a first radiator 201 and the second radiation portion 220 in a second radiator 202 in the first direction X are set to be the same, and only the lengths of the first radiation portion 210 and the third radiation portion 230 in each radiator are required to be adjusted to adjust the length relationship between the first radiator 201 and the second radiator 202 in the first direction X, to compensate for the uneven radiation of the radiator.

In one embodiment, the first radiation portion 210 and the third radiation portion 230 in the first radiator 201 are set to have a fourth length, and the first radiation portion 210 and the third radiation portion 230 in the second radiator 202 are set to have a fifth length, wherein:

As shown in FIGS. 9, 11, and 12, in the case that a flexible substrate 10 includes a first bendable portion, in a radiator 20 located on the first bendable portion, a fourth length of a first radiation portion 210 in a first radiator 201 is greater than a fifth length of a first radiation portion 210 in a second radiator 202. Since each of a third radiation portion 230 and the first radiation portion 210 in the first radiator 201 has the fourth length, and each of a third radiation portion 230 and the first radiation portion 210 in the second radiator 202 has the fifth length, the length of the third radiation portion 230 in the first radiator 201 can also be greater than the length of the third radiation portion 230 in the second radiator 202. Thus, the second radiator 202 in each radiator remains the same, and the length of the first radiator 201 in the first direction X can be greater than the length of the second radiator 202 in the first direction X only by adjusting the lengths of the first radiation portion 210 and the third radiation portion 230 in each radiator, and the radiator located on the outside is designed to have a greater length to allow the radiation center of the radiator located on the outside to be shifted leftwards, and to compensate for the uneven radiation of the outer radiator.

As shown in FIGS. 10 to 12, in the case that a flexible substrate 10 includes a second bendable portion, in a radiator 20 located on the second bendable portion, a fourth length of a first radiation portion 210 in a first radiator 201 is smaller than a fifth length of a first radiation portion 210 in a second radiator 202. Since each of a third radiation portion 230 and the first radiation portion 210 in the first radiator 201 has the fourth length, and each of a third radiation portion 230 and the first radiation portion 210 in the second radiator 202 has the fifth length, and the length of the third radiation portion 230 in the first radiator 201 can also be smaller than the length of the third radiation portion 230 in the second radiator 202. Thus, the second radiator 202 in each radiator remains the same, and the length of the first radiator 201 in the first direction X can be smaller than the length of the second radiator 202 in the first direction X only by adjusting the lengths of the first radiation portion 210 and the third radiation portion 230 in each radiator, and the radiation center of the radiator located on the outer side is shifted rightwards by designing the radiator located on the outer side to have a smaller length, and to compensate for the uneven radiation of the radiator.

In an embodiment, FIG. 9 shows a schematic top view of another antenna with a flexible substrate including a first bendable portion, FIG. 11 shows a schematic top view of an area B in the antenna shown in FIG. 9, and FIG. 12 shows a schematic top view of an area B′ in the antenna shown in FIG. 9. As shown in FIGS. 9, 11, and 12, each radiator 20 has a first radiation portion 210, a second radiation portion 220, and a third radiation portion 230 connected in sequence. In the first direction X, a second radiation portion 220 in a first radiator 201 and a second radiation portion 220 in a second radiator 202 have the same length, each of a first radiation portion 210 and a third radiation portion 230 in the first radiator 201 has a fourth length, and a first radiation portion 210 in the second radiator 202 has a fifth length. In the radiator 20 located on the first bendable portion, the fourth length of the first radiation portion 210 (and the third radiation portion 230) in the first radiator 201 is greater than the fifth length of the first radiation portion 210 in the second radiator 202.

In one embodiment, the total current density distribution of multiple radiators is uniform. When the first bendable portion in the antenna substrate protrudes due to bending, on the first bendable portion, the radiator located on the outer side may be designed to have a larger length than the radiator located on the inner side, and the radiation center of the radiator located on the outer side is shifted leftwards, to compensate for the uneven radiation of the radiator.

In an embodiment, FIG. 10 shows a schematic top view of another antenna with a flexible substrate including a second bendable portion, FIG. 11 shows a schematic top view of an area B in the antenna shown in FIG. 10, and FIG. 12 shows a schematic top view of an area B′ in the antenna shown in FIG. 10. As shown in FIGS. 10 to 12, each radiator 20 has a first radiation portion 210, a second radiation portion 220, and a third radiation portion 230 connected in sequence. In the first direction X, a second radiation portion 220 in a first radiator 201 and a second radiation portion 220 in a second radiator 202 have the same length, each of a first radiation portion 210 and a third radiation portion 230 in the first radiator 201 has a fourth length, and a first radiation portion 210 in the second radiator 202 has a fifth length. In the radiator 20 located on the second bendable portion, the fourth length of the first radiation portion 210 (and the third radiation portion 230) in the first radiator 201 is smaller than the fifth length of the first radiation portion 210 in the second radiator 202.

In one embodiment, the total current density distribution of multiple radiators is uniform. When the second bendable portion in the antenna substrate is recessed due to bending, on the second bendable portion, the radiator located on the outer side may be designed to have a smaller length than the radiator located on the inner side, and the radiation center of the radiator located on the outer side is shifted rightwards. The shift of the radiation center can compensate for the change of the radiation intensity caused by the bending of the antenna substrate, and the lengths of the radiators located on the inner side and the outer side may be reasonably adjusted to adjust the shift degree of the radiation centers of the radiators, to realize compensation for the uneven radiation of the radiators.

In an embodiment, as shown in FIGS. 9 to 12, a radiator 20 is in the shape of a rectangle, and the long axis of the rectangle is parallel to the first direction X. The radiator is of a rectangular structure, which can facilitate the adjustment of the lengths of the first radiation portion 210 and the second radiation portion 220, and the process manufacturing is facilitated, and the shift degree of the radiation center of the radiator can be used to compensate for the change of the radiation intensity caused by the bending of the antenna substrate by reasonably setting the lengths of the first radiation portions 210 and the third radiation portions 230 in different radiators, to facilitate the compensation for the uneven radiation of the radiators.

In some embodiments, as shown in FIGS. 9 to 12, each first area 101 of a flexible substrate 10 has multiple first radiators 201. As shown in FIGS. 9, 11, and 12, in the case that a bendable portion is a first bendable portion, on the same first area 101, fourth lengths of first radiation portions 210 in first radiators 201 increase gradually along a direction away from a second area 102. As shown in FIGS. 10 to 12, in the case that a bendable portion is a second bendable portion, on the same first area 101, fourth lengths of first radiation portions 210 in first radiators 201 decrease gradually along the direction away from the second area 102.

In one embodiment, when a flexible antenna is applied to a specific scenario and an antenna substrate is bent, radiators located at different positions on the antenna substrate also incline along with the bending of the antenna substrate. The radiator located on the outer side inclines outward along with the bending of the antenna substrate, and different radiators have different inclination angles. In a direction from the middle of the antenna substrate to the outer side, the inclination angles of the different radiators gradually increase, that is, a radiator closest to the middle has the smallest inclination angle, and a radiator located on the outermost side has the largest radiation angle. Based on this, in the above embodiments of the present application, the radiation centers of the radiators can be gradually shifted leftwards in the direction by decreasing the lengths of the first radiation portions in the first radiators progressively along a direction away from the middle, and in the case that at least part of the area in the antenna protrudes upwards, the radiation centers gradually shifted leftwards can be used to compensate for the intensity changes caused by the bending of the antenna substrate, to achieve compensation for the uneven radiation of each radiator. In addition, the radiation centers of the radiators can be gradually shifted rightwards in the direction away from the middle of the antenna by increasing the lengths of the first radiation portions in the first radiators progressively along the direction away from the middle, and in the case that at least part of the area in the antenna is recessed downwards, the radiation centers gradually shifted rightwards can be used to compensate for the intensity changes caused by the bending of the antenna substrate, to also achieve compensation for the uneven radiation of each radiator.

In an embodiment, as shown in FIGS. 9 to 12, an antenna according to the embodiment may further include a second feeder 320. The second feeder 320 is connected to a third radiation portion 230 in each radiator 20. The second feeder 320 has an extension direction along the second direction Y.

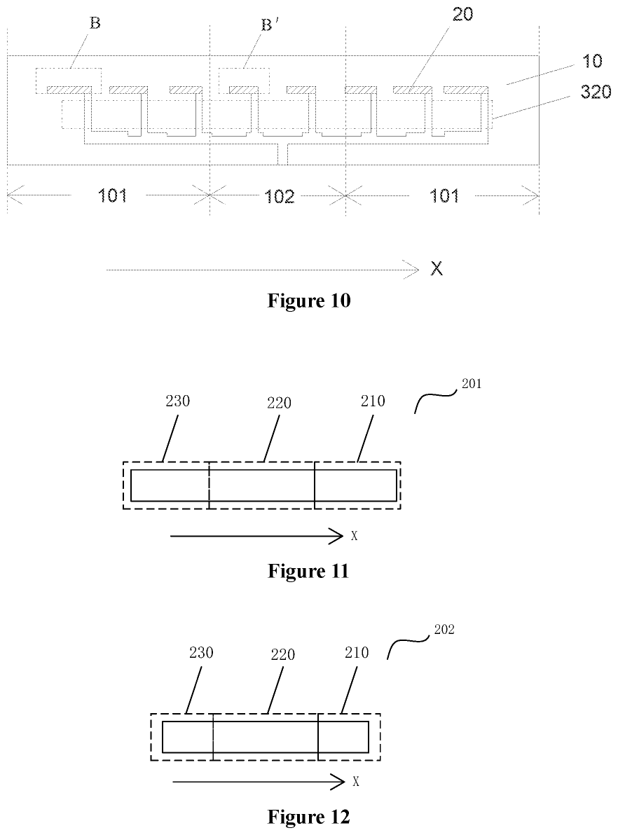

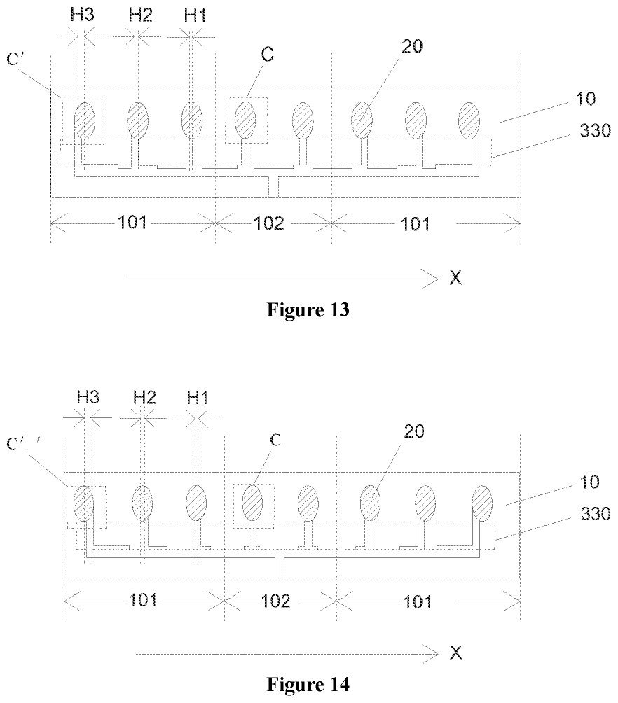

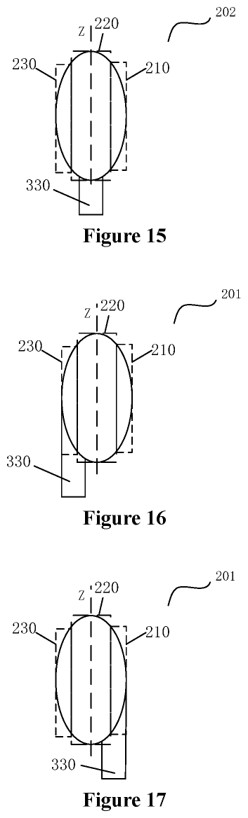

In addition to the shape design of the radiator in the above embodiments, in order to achieve compensation for the uneven radiation of the radiator, in other embodiments, as shown in FIGS. 13 to 17, each radiator 20 has a first radiation portion 210, a second radiation portion 220, and a third radiation portion 230 connected in sequence. The radiator 20 is in the shape of an ellipse. The long axis Z of the ellipse is a first axis. The antenna further includes a third feeder 330 connected to each radiator 20. The third feeder 330 has a second axis. The first axis and the second axis have the same extension direction. As shown in FIG. 15, in a pair of a second radiator 202 and the third feeder 330 that are connected, the first axis is connected to the second axis. As shown in FIGS. 16 and 17, in a pair of a first radiator 201 and the third feeder 330 that are connected, an extension line of the first axis is located on one side of the second axis.

In one embodiment, for the pair of the first radiator 201 and the third feeder 330 that are connected,

In the case that a flexible substrate 10 includes a first bendable portion, in the same sub-area, the extension line of the first axis is located on one side of the second axis towards a second area 102.

In the case that the flexible substrate includes a second bendable portion, in the same sub-area, the extension line of the first axis is located on one side, away from the second area 102, of the second axis.

In an embodiment, FIG. 13 shows a schematic top view of another antenna with a flexible substrate including a first bendable portion, FIG. 15 shows a schematic top view of an area C in the antenna shown in FIG. 13, and FIG. 16 shows a schematic top view of an area C′ in the antenna shown in FIG. 13. As shown in FIGS. 13, 15, and 16, each radiator 20 has a first radiation portion 210, a second radiation portion 220, and a third radiation portion 230 connected in sequence. The radiator 20 is in the shape of an ellipse. The long axis Z of the ellipse is a first axis. The antenna further includes a third feeder 330 connected to each radiator 20. The third feeder 330 has a second axis. The first axis and the second axis have the same extension direction. In a pair of a second radiator 202 and the third feeder 330 that are connected, the first axis is connected to the second axis. In a pair of a first radiator 201 and the third feeder 330 that are connected, an extension line of the first axis is located on one side of the second axis towards a second area 102.

In one embodiment, the total current density distribution of multiple radiators is uniform. When the first bendable portion in the antenna substrate protrudes due to bending, on the first bendable portion, for the second radiator located on the inner side and coaxial with the feeder, the radiation center of the first radiator can be shifted leftwards by designing the axis of the first radiator located on the outer side to be closer to the middle of the antenna than the axis of the feeder, and the positional relationship between the axis of the first radiator and the axis of the feeder can be adjusted to adjust the shift degree of the radiation center of the radiator to the left. Thus, the shift degree of the radiation center can be used to compensate for the change of the radiation intensity caused by the bending of the antenna substrate, to achieve compensation for uneven radiation of the radiator.

In an embodiment, FIG. 14 shows a schematic top view of another antenna with a flexible substrate including a second bendable portion, FIG. 15 shows a schematic top view of an area B in the antenna shown in FIG. 14, and FIG. 17 shows a schematic top view of an area C″ in the antenna shown in FIG. 14. As shown in FIGS. 14, 15, and 17, each radiator 20 has a first radiation portion 210, a second radiation portion 220, and a third radiation portion 230 connected in sequence. The radiator 20 is in the shape of an ellipse. The long axis Z of the ellipse is a first axis. The antenna further includes a third feeder 330 connected to each radiator 20. The third feeder 330 has a second axis. The first axis and the second axis have the same extension direction. In a pair of a second radiator 202 and the third feeder 330, that are connected, the first axis is connected to the second axis. In a pair of a first radiator 201 and the third feeder 330 that are connected, an extension line of the first axis is located on one side, away from a second area 102, of the second axis.

In one embodiment, the total current density distribution of multiple radiators is uniform. When the second bendable portion in the antenna substrate is recessed due to bending, on the second bendable portion, for the second radiator located on the inner side and coaxial with the feeder, the radiation center of the first radiator can be shifted rightwards by designing the axis of the first radiator located on the outer side to be farther away from the middle of the antenna than the axis of the feeder, and the positional relationship between the axis of the first radiator and the axis of the feeder can be adjusted to adjust the shift degree of the radiation center of the radiator to the right. Thus, the shift degree of the radiation center can be used to compensate for the change of the radiation intensity caused by the bending of the antenna substrate, to achieve compensation for uneven radiation of the radiator.

In the above embodiments, as shown in FIGS. 13, 15, and 16, in the case that the flexible substrate include the first bendable portion, in the pair of the first radiator 201 and the third feeder 330 that are connected, in order to ensure the extension line of the first axis of the first radiator 201 to be located on the side, towards the second area 102, of the second axis of the third feeder 330, in the same sub-area, the third radiation portion 230 in the first radiator 201, which has the maximum distance from the second area 102, may be connected to the third feeder 330.

In the above embodiments, as shown in FIGS. 14, 15, and 17, in the case that the flexible substrate includes the second bendable portion, in the pair of the first radiator 201 and the third feeder 330 that are connected, in order to ensure the extension line of the first axis of the first radiator 201 to be located on the side, away from the second area 102, of the second axis of the third feeder 330, in the same sub-area, the first radiation portion 210 in the first radiator 201, which has the maximum distance from the second area, may be connected to the third feeder 330.

In the above embodiments, as shown in FIGS. 13 to 17, the radiator 20 is in the shape of an ellipse. The long axis Z of the ellipse is a first axis, and the third feeder 330 has a second axis. In the first direction X, a first distance is present between an extension line of the first axis and the second axis. There are multiple radiators in each first area. In the same first area 101 of the flexible substrate 10, the first distances corresponding to the first radiators 201 increase progressively along the direction away from the second area 102. In an example, as shown in FIG. 13, along the direction away from the second area 102, a distance between the axis of a first radiator 20 in the first area 101 and the axis of the feeder 300 is H1, a distance between the axis of a second radiator 20 in the first area 101 and the axis of the feeder 300 is H2, and a distance between the axis of a third radiator 20 in the first area 101 and the axis of the feeder 300 is H3, and H1>H2>H3. In another example, as shown in FIG. 14, in the direction away from the second area 102, a distance between the axis of a first radiator 20 in the first area 101 and the axis of the feeder 300 is h1, a distance between the axis of a second radiator 20 in the first area 101 and the axis of the feeder 300 is h2, and a distance between the axis of a third radiator 20 in the first area 101 and the axis of the feeder 300 is h3, and h1>h2>h3.

In one embodiment, when the flexible antenna is applied to a specific scenario and the antenna substrate is bent, the radiators located at different positions on the antenna substrate also incline with the bending of the antenna substrate. The radiator located on the outer side inclines outward with the bending of the antenna substrate, and different radiators have different inclination angles. In the direction from the middle of the antenna substrate to the outer side, the inclination angles of the different radiators gradually increase, that is, a radiator closest to the middle has the smallest inclination angle, and a radiator located on the outermost side has the largest radiation angle. Based on this, in the above embodiments of the present application, in the case that at least part of the area in the antenna protrudes upwards, the radiation centers of the radiators can be gradually shifted leftwards in the direction away from the middle of the antenna by increasing the distances between the axes of the radiators and the axes of the connected third feeders progressively, to achieve compensation for the uneven radiation of each radiator. In the case that at least part of the area in the antenna is recessed downwards, the radiation centers of the radiators can be gradually shifted rightwards in the direction away from the middle of the antenna by increasing the distances between the axes of the radiators and the axes of the connected third feeders progressively, to achieve compensation for the uneven radiation of each radiator.

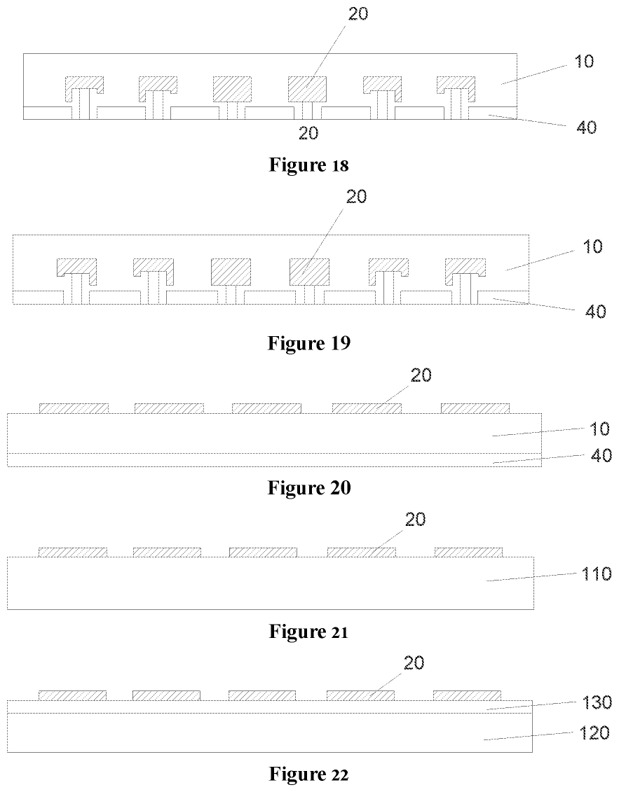

In the antenna of the embodiment, the flexible substrate has a second surface opposite to the first surface. The antenna further includes a ground electrode. As shown in FIGS. 18 and 19, both the ground electrode 40 and the radiator 20 may be located on the side of the flexible substrate 10 having the first surface. The ground electrode and the radiator may also be located on different surfaces. In an embodiment, as shown in FIG. 20, the ground electrode 40 is located on a side, facing away from the radiator 20, of the flexible substrate 10. Each of the ground electrode 40 and the radiator 20 may be a metal layer. The material of the metal layer may include but is not limited to at least one of Mo and Cu, which is not specifically limited in the embodiments of the present application.

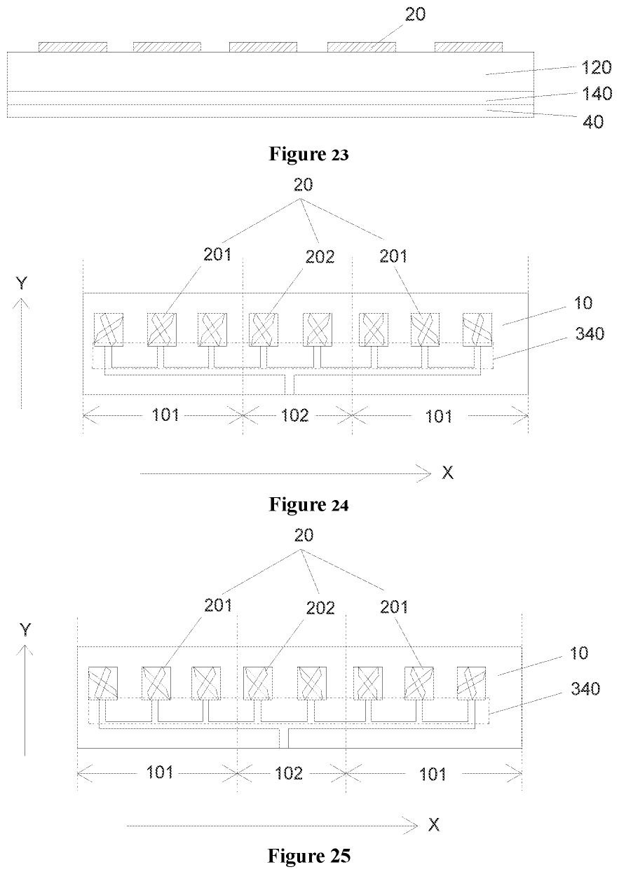

In the above antenna of the embodiment, as shown in FIGS. 21 and 23, the flexible substrate includes a flexible material layer. The flexible material layer may include flexible glass 110 or an organic material layer 120. By using the flexible material, the flexible antenna can be applied to a specific scenario to bend the substrate without affecting the performance of the antenna. An organic material forming the organic material layer 120 includes but is not limited to polyimide, which is not specifically limited in the embodiments of the present application.

Taking the flexible substrate in the antenna including flexible glass as an example, as shown in FIG. 21, an antenna includes a flexible substrate 10 and multiple radiators 20. The flexible substrate 10 includes flexible glass 110. The multiple radiators 20 are distributed and spaced apart on a surface of the flexible glass 110.

In the embodiment, the flexible substrate of the antenna includes the organic material layer. In order to enhance the adhesion between the metal layer, such as the ground electrode 40 and/or the radiator 20, and the organic material layer, an insulation layer may also be provided between the metal layer and the organic material layer. The lattice difference between the metal layer and the organic material layer can be transited by using the insulation layer as a transition layer, to improve the adhesion between the metal layer and the organic material layer. An insulation material that form the insulation layer may include but is not limited to silicon nitride, which is not specifically limited in the embodiments of the present application.

In an embodiment, the radiator 20 is a metal layer. As shown in FIG. 21, an antenna includes a flexible substrate 10 and multiple radiators 20. The multiple radiators 20 are distributed and spaced apart on a first surface of the flexible substrate 10. The flexible substrate 10 includes an organic material layer 120 and a first insulation layer 130. The organic material layer 120 has a third surface on one side, towards the radiators 20, of the organic material layer 120. The radiators 20 are located on one side, facing away from the third surface of the organic material layer 120, of a first insulation layer 130. Since the first insulation layer 130 is arranged between the radiators 20 and the organic material layer 120, the adhesion between the two is improved.

In another embodiment, the ground electrode 40 is a metal layer. As shown in FIG. 22, an antenna includes a flexible substrate 10 and multiple radiators 20. The multiple radiators 20 are distributed and spaced apart on a first surface of the flexible substrate 10. The flexible substrate 10 includes an organic material layer 120 and a first insulation layer 130. The organic material layer 120 has a fourth surface on one side, facing away from the radiators 20, of the organic material layer 120. A second insulation layer 140 covers the fourth surface. A ground electrode 40 is located on one side, facing away from the fourth surface, of the second insulation layer. Since the second insulation layer 140 is arranged between the ground electrode 40 and the organic material layer 120, the adhesion between the two is improved.

It should be noted that, the insulation layers may also be arranged between the radiators and the organic material layer, and between the ground electrode and the organic material layer, which is not specifically limited in the embodiments of the present application.

According to the embodiment of the present application, another antenna is provided. As shown in FIGS. 24 to 28, the antenna includes a flexible substrate and multiple radiators.

The flexible substrate 10 has a first surface. The multiple radiators 20 are distributed and spaced apart along the first direction. The flexible substrate includes a first area 101 and a second area 102. In the first direction, the first area 101 is located on at least one side of the second area 102. At least one first radiator 201 among the multiple radiators 20 is located in the first area 101, and at least one second radiator 202 among the multiple radiators 20 is located in the second area 102.

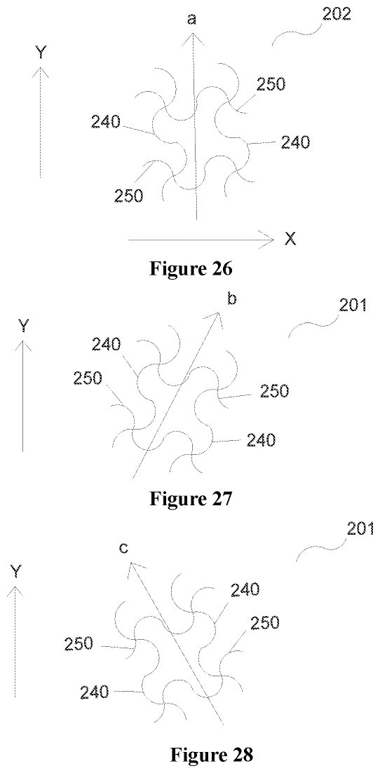

Each radiator 20 is of a grid structure formed by the intersection of multiple first metal wires 240 and multiple second metal wires 250. An extension direction of the first metal wires 240 is perpendicular to an extension direction of the second metal wires 250. Two adjacent first metal wires 240 and two adjacent second metal wires 250 form a radiation unit. In the radiation unit in the second radiator 202, as shown in FIG. 26, the extension direction a of the first metal wires 240 is perpendicular to the first direction X and parallel to the second direction Y of the first surface. In the radiation unit in the first radiator 201, as shown in FIGS. 27 and 28, there is an included angle between the extension direction b of the first metal wires 240 and the second direction Y.

Through the above embodiments, in view of the uneven radiation intensity of the radiator caused by the bending of the antenna substrate, a topological shape design is performed on the radiator on the antenna substrate. When the antenna substrate is not bent, end portions on both sides of the radiator located on the outer side can have different radiation intensities. When the flexible radiator is bent along with the antenna substrate, radio frequency transmission lines with different topological shapes can have different radiation directions to achieve compensation for the uneven radiation of the radiator, and when the antenna substrate is bent, the radiator can achieve compensation for the uneven radiation caused by bending deformation.

For the antenna substrate that protrudes after being bent, since one end, towards the outer side, of the radiator inclines downwards along with the bending of the antenna substrate, the radiation intensity decreases from the inner side to the outer side. In the embodiment of the present application, the topological shape design is performed on the radiator on the antenna substrate, and under the condition that the radiation intensity of the radiator on the inner side is kept uniform, the radiator located on the outer side has a radiation direction towards the inner side. In the radiation direction, the radiation intensity of an end portion of a side, towards the outer side, of the radiator is greater than the radiation intensity of an end portion of a side towards the inner side, to achieve compensation for the uneven radiation of the radiator.

In addition, for the antenna substrate that is recessed after being bent, since one end, towards the outer side, of the radiator inclines upwards along with the bending of the antenna substrate, the radiation intensity increases from the inner side to the outer side. In the embodiment of the present application, the topological shape design is performed on the radiator on the antenna substrate, and under the condition that the radiation intensity of the radiator on the inner side is kept uniform, the radiator located on the outer side has a radiation direction away from the inner side. In the radiation direction, the radiation intensity of an end portion of a side, towards the outer side, of the radiator is smaller than the radiation intensity of an end portion of a side towards the inner side, to achieve compensation for the uneven radiation of the radiator.

The embodiments of the present application are clearly and completely described below in conjunction with the drawings in the embodiments of the present application.

FIG. 1 shows a schematic cross-sectional structural diagram of an antenna according to an embodiment. As shown in FIG. 1, the antenna includes a flexible substrate 10 and multiple radiators 20. The multiple radiators 20 are distributed and spaced apart along the first direction X on a first surface of the flexible substrate 10. As shown in FIGS. 27 and 28, each radiator is of a grid structure formed by the intersection of multiple first metal wires 240 and multiple second metal wires 250. Each of the first metal wire 240 and the second metal wire 250 may include but is not limited to a copper wire, which is not specifically limited in the embodiments of the present application.

In some embodiments, the flexible substrate includes at least one bendable portion. Each bendable portion has a sub-area located in the first surface. Each sub-area has a second area and first areas located on opposite sides of the second area. The bendable portion can be bent in different application scenarios, and the antenna is suitable for the application scenarios. When a flexible antenna in the conventional technology is applied in a specific scenario and an antenna substrate is bent, radiators located at different positions on the antenna substrate are also bent with the antenna substrate. The radiator located on the outer side inclines outwards with the bending of the antenna substrate, so the radiation intensity of the radiator is uneven. In the embodiment, the topological shape design is performed on the radiator on the antenna substrate, and under the condition that the radiation intensity of the radiator on the inner side is kept uniform, the radiator located on the outer side has a radiation direction towards the inner side. In the radiation direction, the radiation intensity of the end portion of the side, towards the outer side, of the radiator is greater than the radiation intensity of the end portion of the side towards the inner side, to achieve compensation for the uneven radiation of the radiator.

In an embodiment, the flexible substrate includes a first bendable portion. The first bendable portion has a first bending state in the case of bending. The first bending state satisfies the following conditions: a sub-area corresponding to the first bendable portion is a convex surface, and in the sub-area corresponding to the first bendable portion, the first areas on opposite sides of the second area are arranged opposite to each other.

In one embodiment, FIG. 2 shows a schematic cross-sectional structural diagram of an antenna according to an embodiment that has the first bending state. As shown in FIG. 2, the middle portion of a flexible substrate 10 protrudes upwards, and both sides of the flexible substrate 10 are lower than the middle portion. Multiple radiators 20 are distributed and spaced apart along the first direction X on a first surface of the flexible substrate 10.

In the above embodiment, for an antenna substrate in the conventional technology that protrudes after being bent, an end, towards the outer side, of a radiator inclines downwards with the bending of the antenna substrate, and the radiation intensity decreases from the inner side to the outer side, and the radiation intensity of a side, towards the outer side, of the radiator is decreased, resulting in uneven radiation intensity of the radiator. For the antenna substrate according to the embodiment that protrudes after being bent, the topological shape design is performed on the radiator on the antenna substrate, and under the condition that maintaining the radiation intensity of the radiator on the inner side is kept uniform, the radiator located on the outer side has the radiation direction towards the inner side. In the radiation direction, the radiation intensity of the end portion of the side, towards the outer side, of the radiator is greater than the radiation intensity of the end portion of the side towards the inner side, to achieve compensation for the uneven radiation of the radiator.

In an embodiment, the flexible substrate includes a second bendable portion. The second bendable portion has a second bending state in the case of bending. The second bending state satisfies the following conditions: a sub-area corresponding to the second bendable portion is a concave surface, and in the sub-area corresponding to the second bendable portion, the first areas on opposite sides of the second area are arranged opposite to each other.

In one embodiment, FIG. 3 shows a schematic cross-sectional structural diagram of an antenna according to an embodiment that has the second bending state. As shown in FIG. 3, the middle portion of a flexible substrate 10 is recessed downwards, and both sides of the flexible substrate 10 are higher than the middle portion. Multiple radiators 20 are distributed and spaced apart along the first direction X on a first surface of the flexible substrate 10.

In the above embodiment, for an antenna substrate in the conventional technology that is recessed after being bent, an end, towards the outer side, of a radiator inclines upwards with the bending of the antenna substrate, so the radiation intensity increases from the inner side to the outer side, and the radiation intensity of a side, towards the outer side, of the radiator is increased, which also leads to uneven radiation intensity of the radiator. For the antenna substrate according to the embodiment that is recessed after being bent, the topological shape design is performed on the radiator on the antenna substrate, and under the condition that the radiation intensity of the radiator on the inner side is kept uniform, the radiator located on the outer side has the radiation direction away from the inner side. In the radiation direction, the radiation intensity of the end portion of the side, towards the outer side, of the radiator is smaller than the radiation intensity of the end portion of the side, towards the inner side, to achieve compensation for the uneven radiation of the radiator.

In an embodiment, the flexible substrate includes a first bendable portion and a second bendable portion. The first bendable portion has a first bending state in the case of bending, and the first bending state satisfies the following conditions: a sub-area corresponding to the first bendable portion is a convex surface, and in the sub-area corresponding to the first bendable portion, the first areas on opposite sides of the second area are arranged opposite to each other. The second bendable portion has a second bending state in the case of bending, and the second bending state satisfies the following conditions: a sub-area corresponding to the second bendable portion is a concave surface, and in the sub-area corresponding to the second bendable portion, the first areas on opposite sides of the second area are arranged opposite to each other.

In one embodiment, FIG. 4 shows a schematic cross-sectional structural diagram of an antenna according to an embodiment that has the first bending state and the second bending state. As shown in FIG. 4, a flexible substrate includes a first bendable portion W1 and a second bendable portion W2. The middle portion of the first bendable portion W1 protrudes upwards, resulting in two sides of the flexible substrate 10 being lower than the middle portion. Multiple radiators 20 are distributed and spaced apart along the first direction X on a first surface of the flexible substrate 10. The middle portion of the second bendable portion W2 is recessed downwards, resulting in two sides of the flexible substrate 10 being higher than the middle portion. Multiple radiators 20 are distributed and spaced apart along the first direction X on the first surface of the flexible substrate 10.

In the above embodiment, for an antenna substrate in the conventional technology where the first area protrudes after being bent and the second area protrudes after being bent, in the first area, an end, towards the outer side, of a radiator inclines downwards with the bending of the antenna substrate, so the radiation intensity decreases from the inner side to the outer side, and the radiation intensity of a side, towards the outer side, of the radiator is decreased. In the second area, an end, towards the outer side, of a radiator inclines upwards with the bending of the antenna substrate, so the radiation intensity increases from the inner side to the outer side, and the radiation intensity of a side, towards the outer side, of the radiator is increased, and thus the radiation intensity of the radiator is uneven. For the antenna substrate according to the embodiment, where the first bendable portion protrudes after being bent and the second bendable portion protrudes after being bent, the topology shape design is performed on the radiator on the antenna substrate. On the first bendable portion, the radiation intensity of the end portion of the side, towards the outer side, the radiator is greater than the radiation intensity of the end portion of the side towards the inner side, and the radiator located on the outer side has radiation compensation towards the inner side. On the second bendable portion, the radiation intensity of the end portion of the side, towards the outer side, of the radiator is smaller than the radiation intensity of the end portion of the side towards the inner side, and the radiator located on the outer side has radiation compensation away from the inner side, achieving compensation for the uneven radiation of the radiator.

As shown in FIGS. 24 and 25, the antenna according to an embodiment may further include a fourth feeder 340 connected to each radiator. In the first direction X, the fourth feeder 340 is located on a first side of multiple radiators 20, and an extension direction of the fourth feeder 340 is the second direction Y.

In this embodiment, the topology shape design is performed on the radiator on the antenna substrate to compensate for the uneven radiation of the radiator. In some embodiments, as shown in FIGS. 24 to 28, each radiator 20 is of a grid structure formed by the intersection of multiple first metal wires 240 and multiple second metal wires 250. An extension direction of the first metal wires 240 is perpendicular to an extension direction of the second metal wire 250. Two adjacent first metal wires 240 and two adjacent second metal wires 250 form a radiation unit.

As shown in FIGS. 24, 26, and 27, in the case that the flexible substrate 10 includes a first bendable portion, in a sub-area corresponding to the first bendable portion, the first metal wire 240 in the second radiator 202 has the same extension direction a as a first extension line, and the first metal wire 240 in the first radiator 201 has the same extension direction b as a second extension line. The first extension line intersects with the second extension line at a second side opposite the first side. The extension directions a and b may be understood as an extension direction of a straight line formed by fitting the curve of the first metal wire 240.

As shown in FIGS. 25, 26, and 28, in the case that the flexible substrate 10 includes a second bendable portion, in a sub-area corresponding to the first bendable portion, the first metal wire 240 in the second radiator 202 has the same extension direction a as a first extension line, and the first metal wire 240 in the first radiator 201 has the same extension direction c as a third extension line. The first extension line intersects with the third extension line at the first side. Similarly, the extension direction c may also be understood as an extension direction of a straight line formed by fitting the curve of the first metal wire 240.

It should be noted that, the extension direction a is the same as the radiation direction of the radiation unit in the second radiator, and the extension directions b and c are the same as the radiation direction of a corresponding radiation unit in the first radiator. In one embodiment, as shown in FIGS. 26 to 28, an electric field is formed between the fed radiator and the ground electrode, the second metal wire 250, which has the same extension direction as the direction of the electric field after being fitted as a straight line, is determined as a radiation edge of the radiation unit, and then an extension direction of a connection line of the midpoints of the two second metal wires 250 in the radiation unit is the radiation direction of the radiation unit.

In an embodiment, FIG. 24 shows a schematic top view of another antenna with a flexible substrate including a first bendable portion, FIG. 26 shows a schematic top view of a second radiator in the antenna shown in FIG. 24, and FIG. 27 shows a schematic top view of a first radiator in the antenna shown in FIG. 24. As shown in FIGS. 24, 26, and 27, each radiator 20 is of a grid structure formed by the intersection of multiple first metal wires 240 and multiple second metal wires 250. The extension direction of the first metal wire 240 is perpendicular to the extension direction of the second metal wire 250. Two adjacent first metal wires 240 and two adjacent second metal wires 250 form a radiation unit. In a sub-area corresponding to the first bendable portion, the first metal wire 240 in the second radiator 202 has the same extension direction a as a first extension line, the first metal wire 240 in the first radiator 201 has the same extension direction b as a second extension line, and the first extension line intersects with the second extension line at a second side opposite the first side.

In one embodiment, the total current density distribution of the multiple radiators is uniform. When the first bendable portion in the antenna substrate protrudes due to bending, on the first bendable portion, compared with the radiator located on the inner side, the first metal wire in the second radiator may be designed to have the same extension direction as the first extension line, and the first metal wire in the first radiator may be designed to have the same extension direction as the second extension line, and the first extension line may intersect with the second extension line at the side of the multiple radiators that is away from the fourth feeder, and under the condition that the radiation intensity of the radiator on the inner side is kept uniform, the radiator located on the outer side has the radiation direction towards the inner side. In the radiation direction, the radiation intensity of the end portion of the side, towards the outer side, of the radiator is greater than the radiation intensity of the end portion of the side, towards the inner side, achieving compensation for the uneven radiation of the radiator.

In an embodiment, FIG. 10 shows a schematic top view of another antenna with a flexible substrate including a second bendable portion, FIG. 11 shows a schematic top view of an area B in the antenna shown in FIG. 10, and FIG. 12 shows a schematic top view of an area B′ in the antenna shown in FIG. 10. As shown in FIGS. 10 to 12, each radiator 20 has a first radiation portion 210, a second radiation portion 220, and a third radiation portion 230 connected in sequence. In the first direction X, the second radiation portion 220 in the first radiator 201 and the second radiation portion 220 in the second radiator 202 have the same length, and each of the first radiation portion 210 and the third radiation portion 230 in the first radiator 201 has a fourth length. The first radiation portion 210 in the second radiator 202 has a fifth length. In the radiator 20 located on the second bendable portion, the fourth length of the first radiation portion 210 (and the third radiation portion 230) in the first radiator 201 is smaller than the fifth length of the first radiation portion 210 in the second radiator 202.

In one embodiment, the total current density distribution of the multiple radiators is uniform. When the second bendable portion in the antenna substrate is recessed due to bending, on the second bendable portion, compared with the radiator located on the inner side, the first metal wire in the second radiator may be designed to have the same extension direction as the first extension line, and the first metal wire in the first radiator may be designed to have the same extension direction as the third extension line, and the first extension line may intersect with the third extension line at the side of the multiple radiators with the fourth feeder, and under the condition that the radiation intensity of the radiator on the inner side is kept uniform, the radiator located on the outer side has the radiation direction away from the inner side. In the radiation direction, the radiation intensity of the end portion of the side, towards the outer side, of the radiator is smaller than the radiation intensity of the end portion of the side towards the inner side, achieving compensation for uneven radiation of the radiator.

In the above antenna according to the embodiment, the flexible substrate has a second surface opposite to the first surface. The antenna further includes a ground electrode. As shown in FIGS. 18 and 19, both the ground electrode 40 and the radiator 20 may be located on one side of the flexible substrate 10 with the first surface. The ground electrode and the radiator may also be located on different surfaces. For example, as shown in FIG. 20, the ground electrode 40 is located on a side, facing away from the radiator 20, of the flexible substrate 10. Each of the ground electrode 40 and the radiator 20 may be a metal layer. The material of the metal layer may include but is not limited to at least one of Mo and Cu, which is not specifically limited in the embodiments of the present application.

In the above antenna according to the embodiment, as shown in FIGS. 21 and 23, the flexible substrate includes a flexible material layer. The flexible material layer may include flexible glass 110 or an organic material layer 120. By using the above-mentioned types of flexible materials, the flexible antennas can be applied to a specific scenario to bend the substrate without affecting the performance of the antenna. An organic material forming the organic material layer 120 includes but is not limited to polyimide, which is not specifically limited in the embodiments of the present application.

Taking the flexible substrate in the antenna that includes flexible glass as an example, as shown in FIG. 21, the antenna includes a flexible substrate 10 and multiple radiators 20. The flexible substrate 10 includes flexible glass 110. The multiple radiators 20 are distributed and spaced apart on the surface of the flexible glass 110.

In the embodiment, in the case that the flexible substrate of the antenna includes an organic material layer, in order to enhance the adhesion between the metal layer, such as the ground electrode 40 and/or the radiator 20, and the organic material layer, an insulation layer may also be provided between the metal layer and the organic material layer. The lattice difference between the metal layer and the organic material layer can be transited by using the insulation layer as a transition layer, to improve the adhesion between the metal layer and the organic material layer. An insulation material that form the insulation layer may include but is not limited to silicon nitride, which is not specifically limited in the embodiments of the present application.

In an embodiment, the radiator 20 is a metal layer. As shown in FIG. 21, the antenna includes a flexible substrate 10 and multiple radiators 20. The multiple radiators 20 are distributed and spaced apart on a first surface of the flexible substrate 10. The flexible substrate 10 includes an organic material layer 120 and a first insulation layer 130. The organic material layer 120 has a third surface on one side of the organic material layer 120 towards the radiator 20. The radiator 20 is located on one side, facing away from the third surface of the organic material layer 120, of the first insulation layer 130. Since the first insulation layer 130 is arranged between the radiator 20 and the organic material layer 120, the adhesion between the two is improved.

In another embodiment, the ground electrode 40 is a metal layer. As shown in FIG. 22, the antenna includes a flexible substrate 10 and multiple radiators 20. The multiple radiators 20 are distributed and spaced apart on a first surface of the flexible substrate 10. The flexible substrate 10 includes an organic material layer 120 and a first insulation layer 130. The organic material layer 120 has a fourth surface on one side, facing away from the radiator 20, of the organic material layer 120. A second insulation layer 140 covers the fourth surface. The ground electrode 40 is located on one side, facing away from the fourth surface, of the second insulation layer. Since the second insulation layer 140 is arranged between the ground electrode 40 and the organic material layer 120, the adhesion between the two is improved.

It should be noted that, the insulation layers may also be provided between the radiator and the organic material layer, and between the ground electrode and the organic material layer, which is not specifically limited in the embodiments of the present application.

According to the embodiments of the present application, a vehicle is also provided, which includes a vehicle body and the antenna described in any of the above embodiments. The vehicle body has a first curved surface, and the antenna is located on the first curved surface of the vehicle body.

In one embodiment, the first curved surface may be at least part of a surface of any of window glass, a vehicle roof, and a vehicle light in the vehicle. It should be noted that, the first curved surface may be any surface with a curvature in the vehicle, which is not specifically limited in the embodiments of the present application.

It should also be noted that, terms such as “comprise”, “include”, or any other variation thereof are intended to cover non-exclusive inclusion, and a process, method, good, or device that includes a series of elements not only includes the series of elements, but also other elements not explicitly listed, or also includes elements inherent in such a process, method, good, or device. Without further limitations, an element limited by the statement “comprise a . . . ” does not exclude the existence of other identical element in the process, method, good, or device that includes the element.

What is claimed is:

1. An antenna comprising a flexible substrate and a plurality of radiators, wherein:
the flexible substrate has a first surface, and the plurality of radiators are distributed and spaced apart along a first direction at a side of the first surface, the flexible substrate comprises a first area and a second area, the first area is located on at least one side of the second area in the first direction, at least one first radiator among the plurality of radiators is located in the first area, and at least one second radiator among the plurality of radiators is located in the second area; and
the plurality of radiators have a same maximum length in a second direction perpendicular to the first direction and parallel to the first surface, each of the plurality of radiators has a first radiation portion, a second radiation portion, and a third radiation portion connected in sequence, the first radiation portion is located on a side, close the second area, of the second radiation portion, the third radiation portion is located on a side, away from the second area, of the second radiation portion, the first radiation portion and the third radiation portion have a same length in the first direction, each of the at least one first radiator has a first radiation center, each of the at least one second radiator has a second radiation center, in the second radiator, the second radiation center is located on an axis of the second radiation portion, and in the first radiator, the first radiation center is located on one side of an axis of the second radiation portion.

2. The antenna according to claim 1, wherein the flexible substrate comprises at least one bendable portion, each of the at least one bendable portion has a sub-area, the sub-area has the second area and the first areas located on opposite sides of the second area, the bendable portion comprises a first bendable portion and/or a second bendable portion, wherein;
the first bendable portion has a first bending state in the case of bending, and the first bending state satisfies the following conditions: a sub-area corresponding to the first bendable portion is a convex surface; and
the second bendable portion has a second bending state in the case of bending, and the second bending state satisfies the following conditions: a sub-area corresponding to the second bendable portion is a concave surface.

3. The antenna according to claim 2, wherein in the sub-area corresponding to the first bendable portion, the first areas on the opposite sides of the second area are arranged opposite to each other;
wherein in the sub-area corresponding to the second bendable portion, the first areas on the opposite sides of the second area are arranged opposite to each other.

4. The antenna according to claim 2, wherein in the second direction, a maximum length of the first radiation portion is a first length, and a maximum length of the third radiation portion is a second length, wherein:
in a case that the flexible substrate comprises the first bendable portion, in the first radiator located on the first bendable portion, the first length is greater than the second length; and
in a case that the flexible substrate comprises the second bendable portion, in the first radiator located on the second bendable portion, the first length is smaller than the second length.

5. The antenna according to claim 4, wherein each of the first areas has a plurality of radiator, wherein:
in a case that the bendable portion is the first bendable portion, the first length of the first radiation portion in each radiator decreases progressively along a direction away from the second area in a same first area; or
in a case that the bendable portion is the second bendable portion, in the same first area, the second length of the third radiation portion in each radiators decreases progressively along the direction away from the second area.

6. The antenna according to claim 5, wherein in the second direction, a maximum length of the second radiation portion is a third length, and the third length is smaller than a minimum length of the first length and the second length.

7. The antenna according to claim 6, wherein in the same first area, the third length of the second radiation portion in each radiators decreases progressively along the direction away from the second area.

8. The antenna according to claim 6, wherein the first radiation portion is a first rectangle, the second radiation portion is in a second rectangle, the third radiation portion is in a third rectangle, the first length is a length of the first rectangle, and the second length is a length of the third rectangle.

9. The antenna according to claim 4, wherein on a same first area, ends of the first radiation portion, the second radiation portion, and the third radiation portion located on a same side are flush.

10. The antenna according to claim 4, further comprising:
a first feeder connected to the second radiation portion in each radiator, wherein an extension direction of the first feeder is the second direction.

11. The antenna according to claim 2, wherein in the first direction, the second radiation portion in the first radiator has a same length as the second radiation portion in the second radiator, each of the first radiation portion and the third radiation portion in the first radiator has a fourth length, and the first radiation portion in the second radiator has a fifth length, wherein:
in a case that the flexible substrate comprises the first bendable portion, in the radiator located on the first bendable portion, the fourth length is greater than the fifth length; and
in a case that the flexible substrate comprises the second bendable portion, in the radiator located on the second bendable portion, the fourth length is smaller than the fifth length.

12. The antenna according to claim 11, wherein the radiator is in a rectangle and a long axis of the rectangle is parallel to the first direction.

13. The antenna according to claim 11, wherein each of the first areas has a plurality of first radiators, wherein:
in a case that the bendable portion is the first bendable portion, in a same first area, the fourth length of the first radiation portion in each first radiator increases progressively along a direction away from the second area; or
in a case that the bendable portion is the second bendable portion, in the same first area, the fourth length of the first radiation portion in each first radiator decreases progressively along the direction away from the second area.

14. The antenna according to claim 11, further comprising:
a second feeder connected to the third radiation portion in the radiator, and an extension direction of the second feeder is the second direction.

15. The antenna according to claim 2, wherein the radiator is of an ellipse, and a long axis of the ellipse is defined as a first axis, the antenna further comprises a third feeder connected to the radiator, the third feeder has a second axis, and the first axis has a same extension direction as the second axis, wherein:
in a pair of the second radiator and the third feeder that are connected, the first axis is connected to the second axis; and
in a pair of the first radiator and the third feeder that are connected, an extension line of the first axis is located on one side of the second axis.

16. The antenna according to claim 15, wherein
for the pair of the first radiator and the third feeder that are connected:
in a case that the flexible substrate comprises the first bendable portion, in a same sub-area, the extension line of the first axis is located on the side of the second axis towards the second area; and
in a case that the flexible substrate comprises the second bendable portion, in the same sub-area, the extension line of the first axis is located on the side, away from the second area, of the second axis.

17. The antenna according to claim 16, wherein in the first direction, a first distance is present between the extension line of the first axis and the second axis, there are a plurality of radiators in each of the first areas, and in the same first area, the first distances corresponding to the first radiators increase progressively along a direction away from the second area.

18. The antenna according to claim 15, wherein
in a case that the flexible substrate comprises the first bendable portion, in a same sub-area, the third radiation portion in a first radiator, which has a maximum distance from the second area, is connected to the third feeder; and
in a case that the flexible substrate comprises the second bendable portion, in the same sub-area, the first radiation portion in a first radiator, which has a maximum distance from the second area, is connected to the third feeder.

19. A vehicle comprising a vehicle body and an antenna comprising a flexible substrate and a plurality of radiators, wherein:
the flexible substrate has a first surface, and the plurality of radiators are distributed and spaced apart along a first direction at a side of the first surface, the flexible substrate comprises a first area and a second area, the first area is located on at least one side of the second area in the first direction, at least one first radiator among the plurality of radiators is located in the first area, and at least one second radiator among the plurality of radiators is located in the second area; and
the plurality of radiators have a same maximum length in a second direction perpendicular to the first direction and parallel to the first surface, each of the plurality of radiators has a first radiation portion, a second radiation portion, and a third radiation portion connected in sequence, the first radiation portion is located on a side, close the second area, of the second radiation portion, the third radiation portion is located on a side, away from the second area, of the second radiation portion, the first radiation portion and the third radiation portion have a same length in the first direction, each of the at least one first radiator has a first radiation center, each of the at least one second radiator has a second radiation center, in the second radiator, the second radiation center is located on an axis of the second radiation portion, and in the first radiator, the first radiation center is located on one side of an axis of the second radiation portion,
wherein the vehicle body has a first curved surface, and the antenna is located on the first curved surface.

20. A vehicle comprising a vehicle body and an antenna comprising a flexible substrate and a plurality of radiators, wherein:
the flexible substrate has a first surface, and the plurality of radiators are distributed and spaced apart along a first direction at a side of the first surface, the flexible substrate comprises a first area and a second area, the first area is located on at least one side of the second area in the first direction, at least one first radiator among the plurality of radiators is located in the first area, and at least one second radiator among the plurality of radiators is located in the second area; and
the plurality of radiators have a same maximum length in a second direction perpendicular to the first direction and parallel to the first surface, each of the plurality of radiators has a first radiation portion, a second radiation portion, and a third radiation portion connected in sequence, the first radiation portion is located on a side, close the second area, of the second radiation portion, the third radiation portion is located on a side, away from the second area, of the second radiation portion, the first radiation portion and the third radiation portion have a same length in the first direction, each of the at least one first radiator has a first radiation center, each of the at least one second radiator has a second radiation center, in the second radiator, the second radiation center is located on an axis of the second radiation portion, and in the first radiator, the first radiation center is located on one side of an axis of the second radiation portion,
wherein the vehicle body has a first curved surface, and the antenna is located on the first curved surface,
wherein the first curved surface is at least part of a surface of any one of window glass, a roof, and a light in the vehicle.
